(19) United States
(12) Patent Application Publication
(10) Pub. No.: US 2014/0181113 A1
(43) Pub. Date: Jun. 26, 2014

(54) APPARATUS AND METHOD FOR MANAGING RECEIVED FILES

(71) Applicant: Pantech Co., Ltd., Seoul (KR)

(72) Inventors: Min-Jeong KIM, Seoul (KR); Yun-Soo KIM, Anyang-si (KR)

(73) Assignee: Pantech Co., Ltd., Seoul (KR)

(21) Appl. No.: 14/135,057

(22) Filed: Dec. 19, 2013

(30) Foreign Application Priority Data
Dec. 20, 2012 (KR) 10-2012-0149277

(51) Int. Cl. G06F 17/30

(52) U.S. Cl. CPC G06F 17/30601
USPC 707/740

(57) ABSTRACT

A method for managing a file receiving operation includes, receiving a file from an external source, displaying information of the file, classifying the file into a group according to metadata corresponding to the file, and providing a user interface for selecting the group. A method for managing a received file includes classifying the file into a group, displaying the group comprising the file for selection along with information corresponding to the group, identifying an application capable of operating with the file for selection, and executing the selected application.

### CROSS-REFERENCE TO RELATED APPLICATION

This application claims priority to and the benefit under 35 U.S.C. §119(a) of Korean Patent Application No. 10-2012-0149277, filed on Dec. 20, 2012, the entire disclosure of which is incorporated herein by reference for all purposes.

### BACKGROUND

1. Field

The following description relates to an apparatus and a method for managing received files, and more particularly, to an apparatus and a method for displaying and storing received files.

2. Discussion of the Background

Terminal devices, such as smart phones, have been developed as multifunctional multimedia devices capable of taking pictures and making videos, playing back music and video files, executing games, and receiving broadcast programs. In addition, such terminal devices can receive and transmit files from and to an external device.

When receiving files from an external device, a terminal device may not have access to information regarding the received files. For example, when the terminal device receives one or more files from a connected external device, the terminal device is unable to acquire any information from the external device, such as a status of a file receiving operation, and/or information about the file being received (e.g., a file type, the number of currently received files, a file size, etc.). Accordingly, a user of the terminal device may be unable to determine or choose whether to complete the file reception.

### SUMMARY

Exemplary embodiments of the present invention provide an apparatus and a method for managing received files.

Additional features of the invention will be set forth in the description which follows, and in part will be apparent from the description, or may be learned by practice of the invention.

Exemplary embodiments of the present invention provide a method for managing a file receiving operation in a terminal device, the method including receiving a file from an external source; displaying information of the file; classifying the file into a group according to metadata corresponding to the file; and providing a user interface for selecting the group.

Exemplary embodiments of the present invention provide a method for managing a received file, the method including classifying the file into a group; displaying the group comprising the file for selection along with information corresponding to the group; identifying an application capable of operating with the file for selection; and executing the selected application.

Exemplary embodiments of the present invention provide an apparatus to manage a file in a terminal device, the apparatus including a receiving unit to receive a file from an external source; a categorizing unit to categorize the file into a group; and a display unit to display at least one of information of the file and group information corresponding to the group to which the file is categorized.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a diagram illustrating a configuration of a terminal device according to an exemplary embodiment of the present invention.

FIG. 2 is a diagram illustrating status/notification screens according to an exemplary embodiment of the present invention.

FIG. 3, FIG. 4A, FIG. 4B, FIG. 4C, and FIG. 5 are diagrams illustrating display screens for managing received files according to exemplary embodiments of the present invention.

FIG. 6 is a diagram illustrating display screens of an application performing a sharing operation according to exemplary embodiment of the present invention.

FIG. 7 is a diagram illustrating a user interface providing a list of applications capable of supporting a sharing operation for a corresponding group of files according to an exemplary embodiment of the present invention.

FIG. 8 is a diagram illustrating a sharing operation for a text file according to an exemplary embodiment of the present invention.

FIG. 9 and FIG. 10 are diagrams illustrating a user interface for designating a folder for storing a received file according to exemplary embodiments of the present invention.

FIG. 11A and FIG. 11B are diagrams illustrating of a file explorer to identify a folder for storing the received files.

FIG. 12 is a flowchart illustrating a method for displaying received files according to an exemplary embodiment of the present invention.

FIG. 13 is a flowchart illustrating a method for displaying a list of the applications capable of executing a selected file or a group of files according to an exemplary embodiment of the present invention.

FIG. 14 is a flowchart illustrating a method for performing a sharing operation according to an exemplary embodiment of the present invention.

FIG. 15 is a flowchart illustrating a method for storing received files according to an exemplary embodiment of the present invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. It will be understood that for the purposes of this disclosure, “at least one of X, Y, and Z” can be construed as X only, Y only, Z only, or any combination of two or more items X, Y, and Z (e.g., XYZ, XZ, XYY, YZ, ZZ). Throughout the drawings and the detailed description, unless otherwise described, the same drawing reference numerals are understood to refer to the same elements, features, and structures. The relative size and depiction of these elements may be exaggerated for clarity.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. Although some features may be described with respect to individual exemplary embodiments, aspects need not be limited thereto such that features from one or more exemplary embodiments may be combinable with other features from one or more exemplary embodiments.

Hereinafter, an application may include, without limitation, various types of applications for performing one or more operations offered by a terminal device, and initially installed applications and applications downloaded from an external source. For example, the application may include an image viewer application, a camera application, a movie-player application, a documentation-viewer application, an email application, a memo or note application, a messaging application for a short message service or multimedia messaging system, a scheduler application for schedule management, an instant messenger application, and the like.

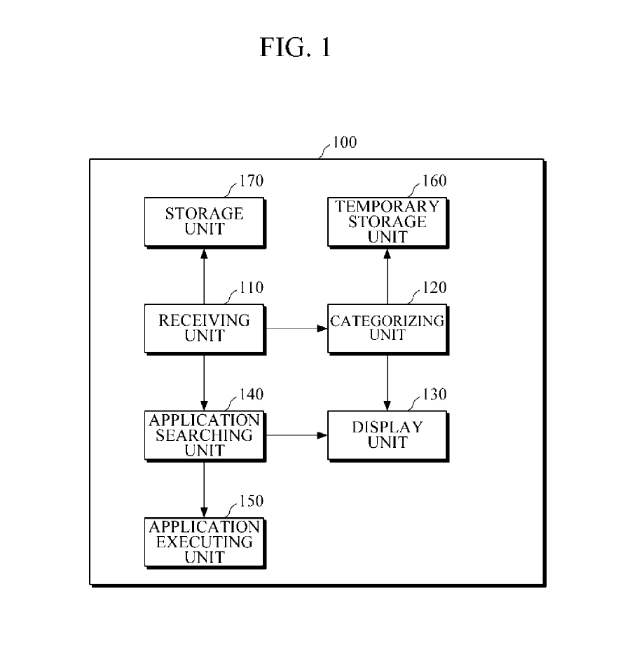

FIG. 1 illustrates a configuration of a terminal device according to an exemplary embodiment of the present invention.

Referring to FIG. 1, terminal device 100 includes a receiving unit 110, a categorizing unit 120, a display unit 130, an application searching unit 140, an application executing unit 150, a temporary storage unit 160, and a storage unit 170. Further, although not shown in FIG. 1, the terminal device 100 may include hardware components, such as one or more processors, a memory, a touch screen display, a camera, and the like. Also, the units, modules, elements, devices, applications, and components of the apparatuses, systems, and/or terminal devices herein described, may include hardware and software, may also include firmware, to perform various operations of the terminal device including those described herein, may be combined or remain separate, and may be stored in one or more storage devices or computer-readable media. Terminal device 100 may be a cellular telephone, a smartphone, a tablet computer, a laptop computer, a desktop computer, and the like.

The receiving unit 110 may receive files from a wired or wirelessly connected external device. For example, the receiving unit 110 may be connected to the external device in a wired manner, and receive files using media transfer protocol (MTP) or, universal serial bus mass storage device class (USB MSC or UMS). In addition, the receiving unit 110 may be connected to the external device using Wi-Fi®, Bluetooth®, near-field communication (NFC), or Wi-Fi Direct®. However, aspects of the invention are not limited thereto, such that the receiving unit 110 may receive files from an external device using a diversity of methods.

The classifying unit 120 may classify the received files into one or more groups based on metadata of the received files. For example, when receiving a number of files, the classifying unit 120 may obtain information on a file type from metadata of the respective received files, and may classify the received files into at least one of an image file group, an audio file group, a video file group, a text file group, and the like, based on the metadata. However, aspects of the invention are not limited thereto, such that the classifying unit 120 may classify the received files based on various criteria.

The display unit 130 may display information about a reception status while a file is in the process of being received. The information about a reception status may include, without limitation, at least one of a title of the received file, a number of files or parts of a file or program to be received, a number of files or parts of a file or program already received, and a current status of a file downloading operation. For example, the display unit 130 may display the information about the reception status on a status/notification bar, which may provide information about reception status of a file being received at the terminal device 100. However, aspects of the invention are not limited thereto, such that the status/notification bar may also include information about the files that have been received. Further, although described as a status/notification bar, aspects need not be limited thereto such that the status may be indicated on a separate screen, a pop-up window or a balloon-type window.

The display unit 130 may display the received files on a group basis. For example, the display unit 130 may display groups of received files using a status/notification bar, a separate status/notification screen, a popup window, and/or an icon displayed on a specific region of a display screen. The status/notification bar may be a user interface to provide the device's status or the status of currently running task. The status/notification bar may include, without limitation, Notification bar (e.g., navigation bar, Quick panel, status bar, etc.) of Android®, Start window of Windows®, and the like.

In addition, the display unit 130 may display a share icon to display a list of applications supporting a sharing operation along with the groups of received files. Further details of the share icon will be provided below.

The application searching unit 140 may search for applications which may be associated with the received files, and provide the search result to the display unit 130. For example, if the received file is an image file, the application searching unit 140 may find an image viewer application to display the image file, or a messaging application, such as an email application and/or SMS/MMS messaging application, which may be capable of having the image file attached thereto.

Additionally, the application searching unit 140 may search for applications capable of supporting a sharing operation, and provide the search result to the display unit 130. For example, the application searching unit 140 may find a Bluetooth® application, a social network service (SNS) application, an email application, or a messaging application, such as an SMS or MMS application, as applications that may be capable of supporting a sharing operation.

In response to a particular application being selected for execution, the application executing unit 150 may associate the received file with the selected application and execute the selected application. For example, if the received file is an image file and the user selects an image viewer application for execution, the application executing unit 150 may associate the image file to the image viewer application and execute the image viewer application.

In addition, if the received file is a text file and the user selects a particular application capable of supporting a sharing operation, the application executing unit 150 may allow sharing of the received file, or execute the selected application to share the received file. For example, if the received file is a text file containing a specific address and the user selects an email application to share the received file, the application executing unit 150 may execute the email application to generate an email with the text file itself being attached thereto, or with the specific address contained in the text file being entered as content in the generated email. Although above examples describe a user selecting the application to share the received file, aspects of the invention are not limited thereto, such that an application may be automatically selected for execution.

The storage unit 160 may store the groups of received files. For example, if folders designated for storing one or more groups of files are set prior to the receipt of files, the storage unit 160 may store the groups of files classified by the classifying unit 120 in the designated folders. In another example, if the folder for a group of files is selected by the user after receiving the files, the storage unit 160 may store one or more of the received files corresponding to the respective group in the selected folder. In addition, if there is a folder corresponding to metadata of one or more of the received files, the storage unit 160 may store the received file in the respective folder. Further, the storage unit 160 may create a folder using the metadata of the file and store the file in the created folder.

The temporary storage unit 170 may store the received data, a portion of a file, or files temporarily. For example, the temporary storage unit 170 may store the received data, a portion of a file or files before the files are classified into groups and stored in the storage unit 160.

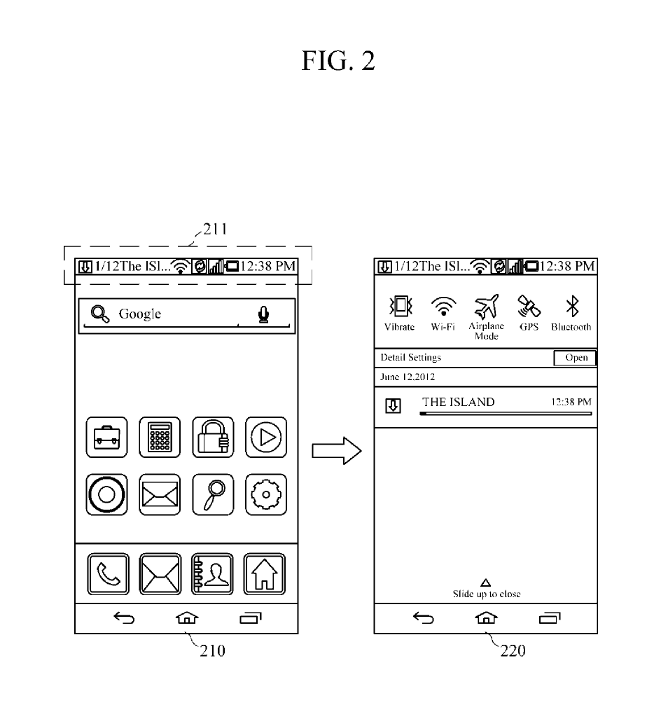

FIG. 2 illustrates status/notification screens according to an exemplary embodiment of the present invention.

Referring to FIG. 2, display screen 210 displays a status of a file downloading operation on a status/notification bar 211 located at an upper portion of the display screen 210, and display screen 220 displays at least some of the information included in the status/notification bar 211, along with additional information, in full screen. The display screen 210 including the status/notification bar 211 may be changed to a full screen as shown in the display screen 220 in response to a dragging operation or other similar operations.

In the status/notification bar 211 on the display screen 210, “1/12” may indicate that the first file out of 12 files is in the process of being downloaded or received, and “The Isl . . . ” corresponding to “The Island” as shown on the display screen 220, indicates the title of the file being downloaded. Although the status/notification bar 211 is displayed a singular row, aspects of the invention are not limited thereto, such that the status/notification bar 211 may include multiple rows to display more information, which may accommodate to display the full title of “The Island” on the status/notification bar 211. In addition, [symbol] symbol displayed on the status/notification bar 211 may represent that the respective file is in the process of being downloaded or received. More specifically, the status/notification bar 211 may display the title of the file being downloaded or received, the number of files to be downloaded, the number of files already downloaded, and a status of a file downloading operation. Although receiving or downloading status is described with respect to number of files among multiple files to be received or downloaded, aspects of the invention are not limited thereto, such that amount of data to be downloaded and/or already downloaded may be described in terms of bytes, portion of a file, percentage of a file, components of a file and the like.

The display screen 220 displayed in full screen displays the title or name of the file “The Island” and the status of downloading the file titled “The Island” in the progress bar. However, aspects of the invention are not limited thereto, such that the display screen may additionally display at least one of a number of files, components of a file, bytes or amount of data to be downloaded; a number of files, a number of components of a file, bytes or amount of data completely or already downloaded; a file type; an indication of a capability to support a sharing operation; metadata of the file being downloaded; rate or reception; start time of file receiving operation; estimated finish time of the file receiving operation, and the like.

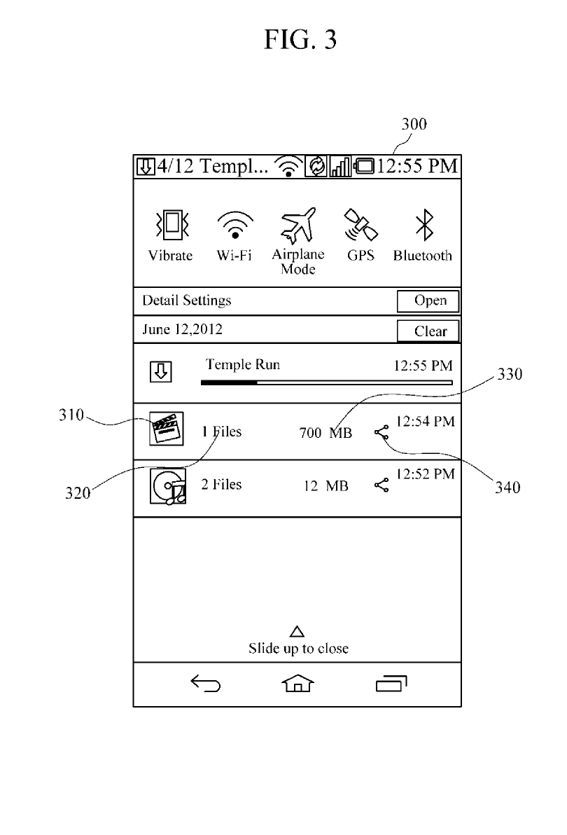

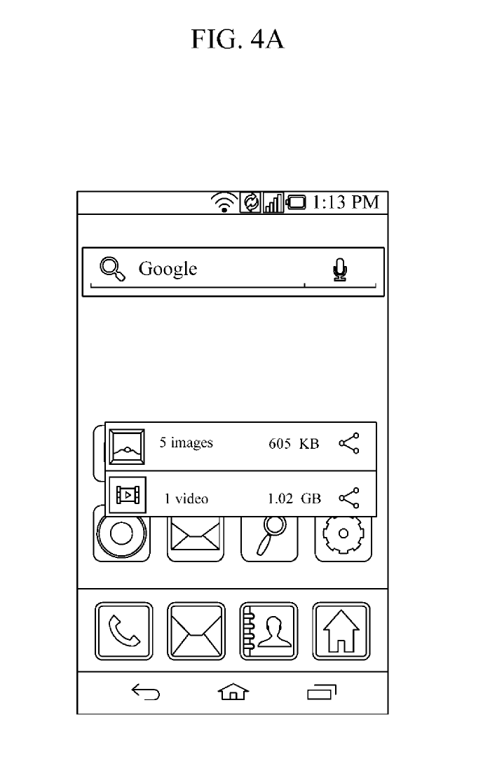

FIG. 3, FIG. 4A, FIG. 4B, FIG. 4C, and FIG. 5 illustrate display screens for managing received files according to exemplary embodiments of the present invention. More specifically, FIG. 3 illustrates a display screen displaying at least some of the information included in a status/notification bar on a full screen, along with information corresponding to files already received by the terminal device. FIG. 4A, FIG. 4B, and FIG. 4C illustrate display screens displaying groups of files in a popup window. FIG. 5 illustrates a display screen displaying groups of files as icons resident on a given region of the display screen.

Referring to FIG. 3, information corresponding to the received files, such as group information corresponding to the received files, along with a status of a file in the process of being downloaded may be displayed on a full screen. More specifically, at least some of the information provided on the status/notification bar 211 may be displayed in full screen in response to an input, such as a dragging operation or other similar operation. One or more groups corresponding to the received files may be displayed on the status/notification screen 300, which may display at least some of the information included in the status/notification bar 211, with or without additional information, on a larger or a full screen. A share icon 340 may be displayed for the displayed groups of files to show a list of applications capable of supporting file sharing operation with other devices for one or more files included in the respective group.

The status/notification screen 300 displays 1 video file and 2 audio files, which are indicated as being downloaded out of 12 files. Further, the status/notification screen 300 displays one or more icons or related information (e.g. share icon 340), for each group of files, which may include a graphical icon 310, number of files 320 for the respective group, file size 330, and a share icon 340, which may indicate whether the one or more files in the respective group are capable of supporting file sharing with other devices.

When both a status of a file in the process of being downloaded and information corresponding to the files that have completed the receiving or downloading process are to be displayed on the status/notification bar, the respective information may be automatically displayed in full screen without a specific instruction. Further, only the status of a file downloading operation may be first displayed and then in response to a user's instruction (e.g., when the user selects a region displaying the status of a file downloading operation), before being switched to display the information corresponding to the already downloaded or received files on the status/notification bar. However, aspects of the invention are not limited thereto, such that one status information (e.g., status of a file downloading operation) may be switched with another status information (e.g., completed downloaded files) automatically according to a time interval or other criteria.

FIG. 4A, FIG. 4B, and FIG. 4C illustrate display screens displaying received files in a popup window on a group basis according to exemplary embodiments of the present invention.

Referring to FIG. 4A, when groups of received files are displayed in a popup window, icons corresponding to each group of files, information on number of files in each group, file size of each group, and share icons, which may indicate whether one or more files in each group are capable of supporting a file sharing operation with other devices, for each group are displayed. More specifically, the classifying unit 120 may classify the received files into one or more groups based on metadata of each file. The display unit 130 may display, in a popup window or on a separate screen, the groups of files along with icons corresponding to each group, information on the number of files in each group, the file size of each group, and share icons, which may indicate whether one or more files in each group are capable of supporting a file sharing operation with other devices, for each group. Referring to FIG. 4A, 5 image files, totaling 605 kilobyte (KB) in size, and 1 video file with 1.02 gigabyte (GB) in size have been downloaded.

Referring to FIG. 4B, the received files are displayed in a popup window on a group basis. More specifically, files corresponding to an audio group are displayed on screen 410. A displayed group of audio files in a popup window on screen 410 may be changed to display another group of files, such as image files, on screen 420 in response to an input, such as, shaking of the device or dragging the popup window. Files belonging to the image file group may be displayed.

Referring to FIG. 4B, 3 audio files “Song 1,” “Song 2,” and “Song 3”, and 3 image files “image 1,” “image 2,” and “image 3” have been downloaded. The display screen 410 displays an audio file group in a popup window, which includes “Song 1,” “Song 2,” and “Song 3” files along with corresponding information (e.g., capability to perform a sharing operation). The display screen 420 displays an image file group in a popup window, which includes “image 1,” “image 2,” and “image 3” files along with corresponding information (e.g., capability to perform a sharing operation). More specifically, once the files have been downloaded, an audio file group may be displayed as shown in the display screen 410, and then in response to an input, such as, shaking of the device or dragging of the popup window, an image file group may appear in the popup window to replace the audio file group as shown in the display screen 420. Both the display screen 410 and the display screen 420 may be switched in response to an input, such as, shaking of the device or dragging of the popup window. However, aspects of the invention are not limited to the shaking or dragging operation to switch from the display screen 410 to the display screen 420, or vice-versa, such that various methods may be used.

Referring to FIG. 4C, groups of received files are displayed with icons, which may indicate or show the number of files belonging to each group.

When 1 audio file and 1 video file have been downloaded, icons and/or information corresponding to each group are displayed in a popup window as shown in the display screen 430. As shown in FIG. 4C, the number of files belonging to each group is displayed in a balloon, popup, or the like. In response to a user's selection of a displayed icon for an audio file group, two menu icons may appear, an icon for displaying a list of applications capable of being associated with the respective audio file group (e.g., “App list” icon) and an icon of a list of applications capable of supporting sharing operation, as shown in the display screen 440. Further, an icon corresponding to an application capable of executing files belonging to a particular group may be displayed instead of the “App list” icon or the icon for displaying a list of applications capable of being associated with the respective file group. The icon corresponding to the application, which may replace the “App list” list icon, may be selected in advance by a user or set as default as a primary application.

FIG. 5 illustrates a diagram of a display screen for managing received files according to an exemplary embodiment of the present invention.

Referring to FIG. 5, icons corresponding to file groups may be located on a given region of the display screen, and the number of files belonging to each group is displayed in a balloon or the like once the file belonging to one of the groups is downloaded or received. In response to one of icons being selected, one or more menu icons may appear as shown in the display screen 440 of FIG. 4C. The one or more menu icons may perform an operation or display information related to the selected menu icon. For example, referring to the display screen 440, a first menu icon may display a list of applications capable of being associated with a group of files when selected and a second menu icon for displaying a list of applications capable of performing or supporting a particular operation, such as, a sharing operation. However, like the example shown in FIG. 3C, aspects of the invention are not limited thereto, such that an icon of an application previously selected by a user or set as default may be resident on the given region of the display screen, instead of the icon representing the group.

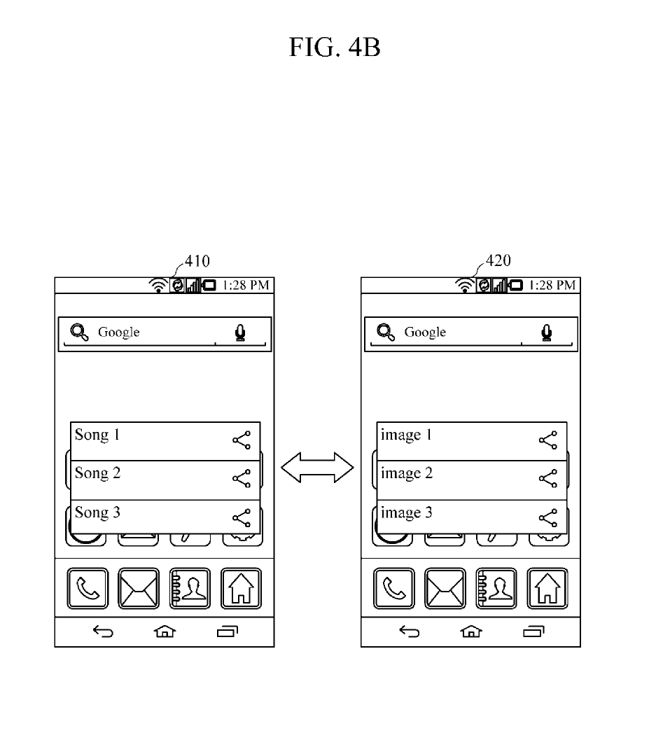

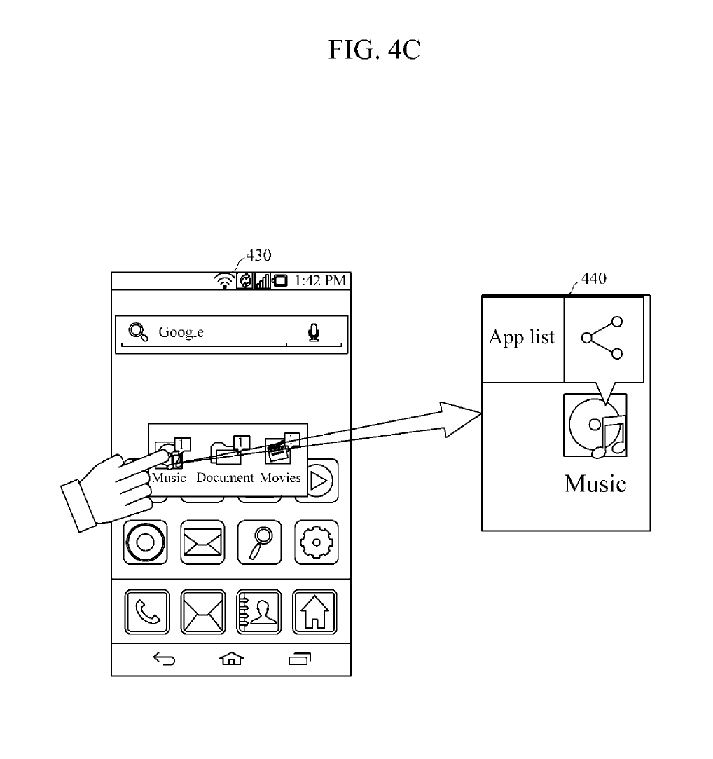

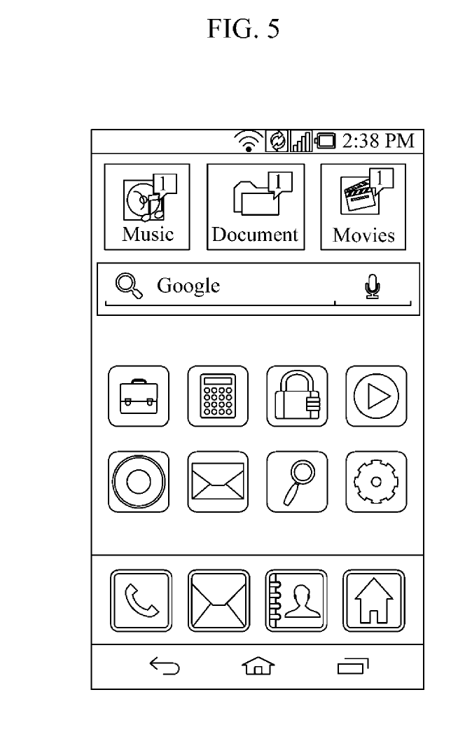

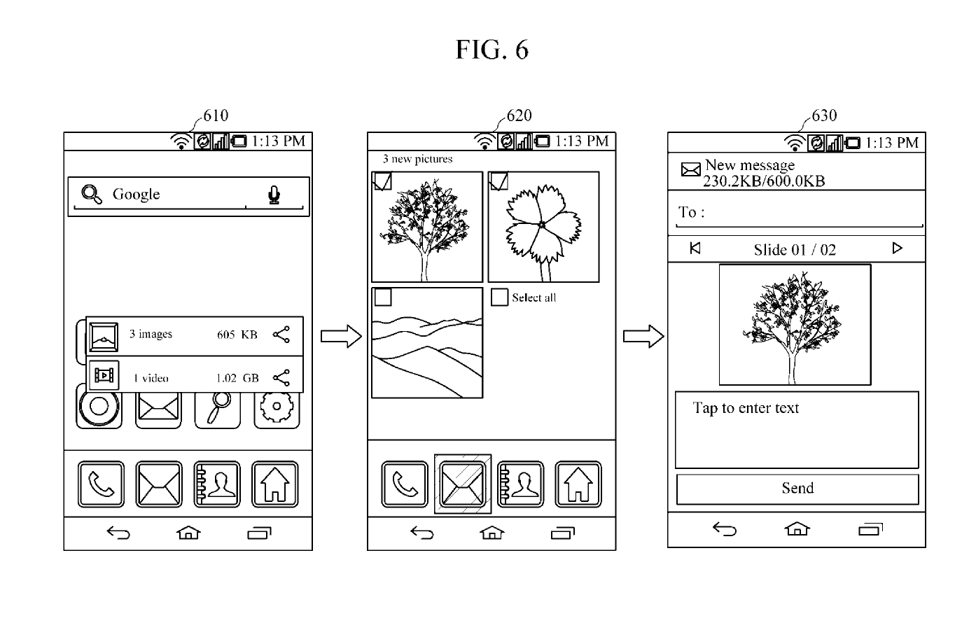

FIG. 6 illustrates display screens of an application performing a sharing operation according to exemplary embodiment of the present invention. Although FIG. 6 illustrates each group of received files being displayed in a popup window, aspects of the invention are not limited thereto, such that the group of files may be displayed on a status/notification bar, using icons resident on a given region of the display screen, or the like.

Referring to FIG. 6, when three image files and one video file have been downloaded, the classifying unit 120 may classify the received files into one or more groups based on corresponding metadata, and the display unit 130 may display the groups of files as shown in the display screen 610. In response to an image file group being selected by a user, images (or thumbnail images of each image) belonging to the image file group are displayed along with a list of related applications as shown in the display screen 620. If two images out of three images and a messaging application are selected, the messaging application may be executed with the selected two images being stored as attachment as shown in the display screen 630.

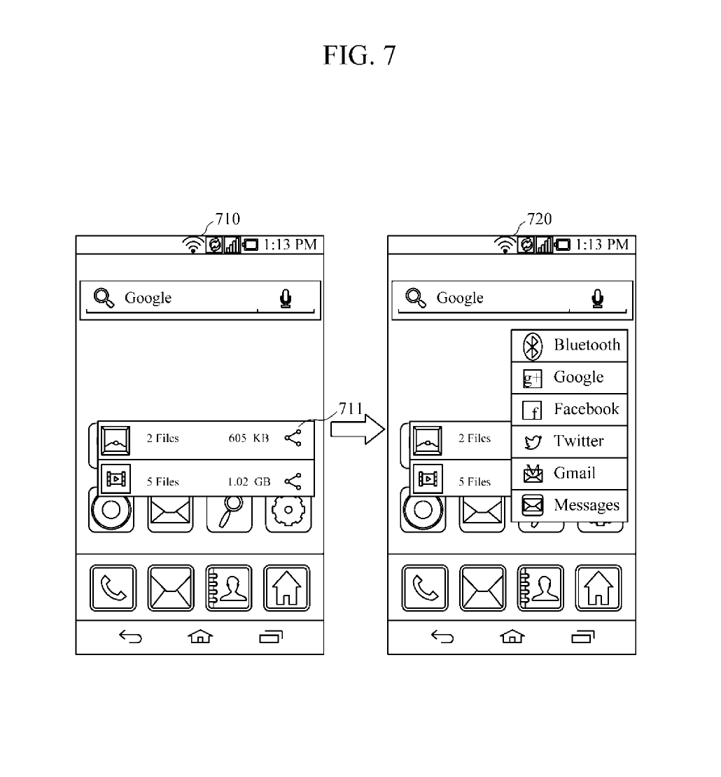

FIG. 7 illustrates a user interface providing a list of applications capable of supporting sharing operation for a corresponding group of files according to an exemplary embodiment of the present invention.

Referring to FIG. 7, when two image files and five audio files have been downloaded as shown in the display screen 710, icons corresponding to an image file group and an audio file group, information on the number of files of each group, and share icons, which may provide a list of applications capable of supporting sharing operation, may be displayed when the respective share icon is selected. More specifically, if share icon 711 for the image file group is selected, a list of applications capable of supporting a sharing operation, which may be determined by the application searching unit 140, is displayed, as shown in the display screen 720. For example, applications that may support Bluetooth®, SNS-related applications (e.g., Facebook®, Twitter®, Cyworld®, and the like), email applications, and messaging applications may be displayed.

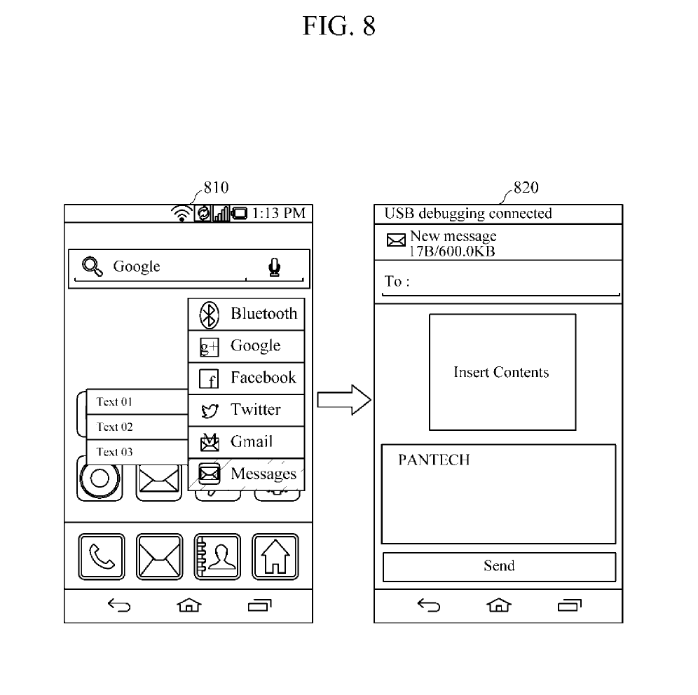

FIG. 8 illustrates a sharing operation for a text file according to an exemplary embodiment of the present invention.

Referring to FIG. 8, three text files, “Text 01,” “Text 02,” and “Text 03” may be downloaded. In an example, Text 02 may correspond to text “Pantech”.

In response to a selection of a share icon for Text 02, as shown in the display screen 810, a list of applications capable of supporting a sharing operation is displayed. In response to a selection of a messaging application, listed under “Messages” from the list displayed on the display screen, the messaging application is executed and the text “Pantech” corresponding to Text 02 may be automatically entered in a message box. More specifically, to share Text 02, which may correspond to text of “Pantech”, with other devices, the messaging application may be executed to automatically insert the content corresponding to Text 02 file. However, aspects of the invention are not limited thereto, such that the text file itself, rather than the content of the text file, may be inserted or attached to be shared with other devices. More specifically, the messaging application may be executed with the text file attached thereto.

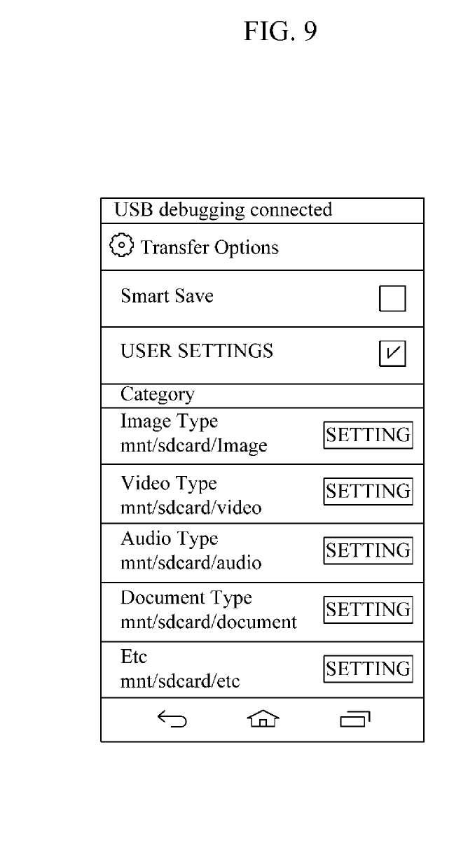

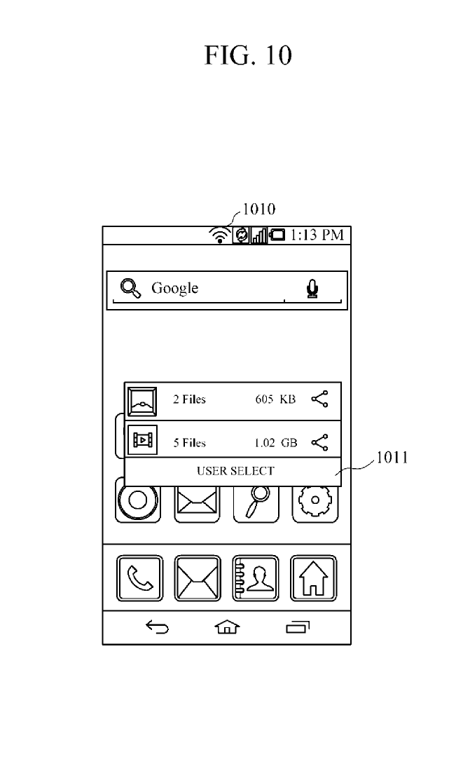

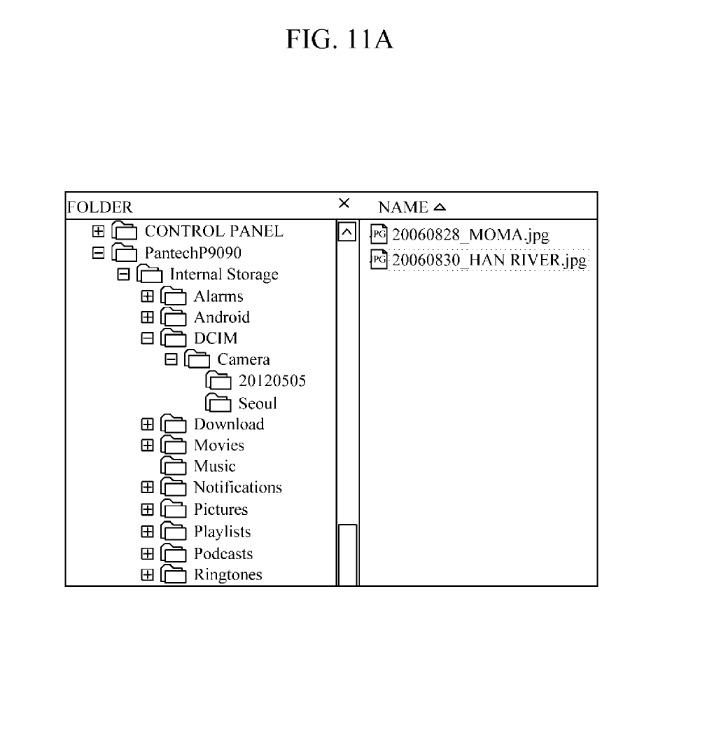

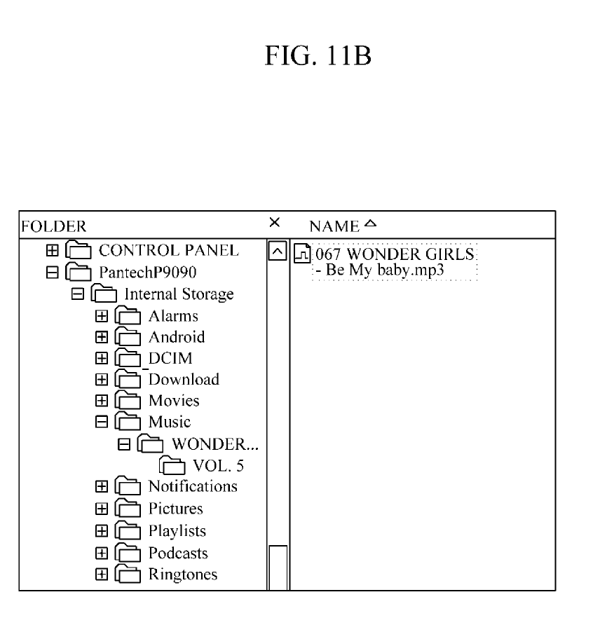

FIG. 9 and FIG. 10 are diagrams illustrating a user interface for designating a folder for storing a received file according to exemplary embodiments of the present invention. FIG. 11A and FIG. 11B illustrate a file explorer to identify a folder for storing the received files. More specifically, FIG. 9 illustrates a user interface in which a folder for each group of files to store received files is determined according to metadata of files to be received or in the process of being received prior to the complete receipt of files. FIG. 10 illustrates a user interface in which a user manually determines folders to store files after the complete receipt of files. FIG. 11A illustrates a file explorer or tree including a folder corresponding to metadata of a received file, which stores the respective received file. FIG. 11B illustrates a file explorer or tree which does not include a folder corresponding to metadata of a received file, and thus generates a folder using the metadata of the received file.

Referring to FIG. 9, prior to receiving files, the user may select folders to store groups of files according to metadata corresponding to files to be received. When the user selects the folders for one or more groups in advance, the received files may be stored in the selected folders according to criteria set by the user.

Referring to FIG. 10, a user interface 1011, which may allow a user to designate one or more folders for each group of the received files, is displayed along with the groups of files. The user may select or designate a folder to store a group of files via the user interface 1011. In response to the user's designation, the received file may be stored in the folder designated for the respective group of files according to the metadata of the file.

Referring to FIG. 11A, image files labeled “MOMA” and “HAN RIVER” may have been received to be stored in a device. In an example, the “HAN RIVER” image file may be an image of the Han river, and may include “Seoul” and “Han river” in its metadata. When an image folder in the storage unit 160 has a sub-folder named “Seoul,” the storage unit 160 may store the “HAN RIVER” image file in the “Seoul” folder.

Referring to FIG. 11B, an audio file labeled “Be My baby” by “WONDER GIRLS” may have been received to be stored in a device. In an example, the “Be My baby” audio file may be a music file or a song included in a 5^{th} music album by a group called Wonder Girls. Here, “Vol. 5” and “Wonder Girls” may be included in the metadata corresponding to the received audio file. If a music folder in the storage unit 160 does not have any sub-folders corresponding to metadata of the received file, sub-folders labeled “Wonder Girls” and “Vol. 5” may be created under the music folder based on the metadata of the received files and the received file may be stored in the created folder.

Although the exemplary embodiments of FIG. 9, FIG. 10, FIG. 11A, and FIG. 11B are described separately from one another with reference to each drawing, aspects of invention are not limited thereto, such that various features of exemplary embodiments may be combined. For example, a user may store each of the received files in the folders, which have been determined for each group of folders prior to receiving the files (see FIG. 9). If the folders are not previously determined for each group of files, a user interface for selecting a folder for each group of files may be displayed along with the group of the received files, thereby enabling the user to select a folder to store the received files (see FIG. 10). If the folders for each group of files are not previously determined and there is no user designation of a folder via the user interface, the received files may be grouped together based on their metadata and then the groups of the files may be stored in corresponding folders (see FIG. 11A and FIG. 11B).

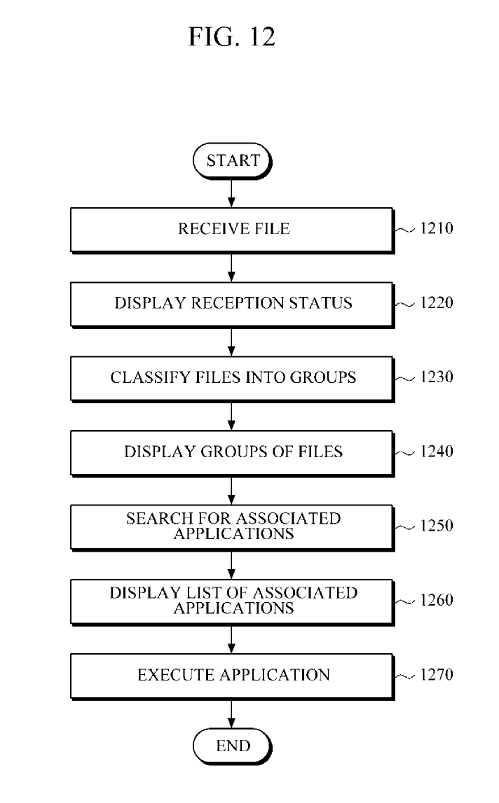

FIG. 12 illustrates a flowchart of a method for displaying received files according to an exemplary embodiment of the present invention. Although method of FIG. 12 is described with respect to a device of FIG. 1, aspects of the invention are not limited thereto.

Referring to FIG. 12, one or more files are received in operation 1210. For example, the receiving unit 110 of FIG. 1 may be connected with an external device in a wired manner and receive files from the external device using MTP or UMS. In addition, the receiving unit 110 may be wirelessly connected with the external device using Wi-Fi®, Bluetooth®, NFC, Wi-Fi Direct®, and the like, and receive files from the external device. However, aspects of the invention are not limited thereto, such that the receiving unit 110 may receive files from the external device using various methods.

While the file is being received, information about a reception status is displayed in operation 1220. For example, the display unit 130 of FIG. 1 may display a title of the received file, number of files to be received, number of files already received, and a status of a file downloading operation on a status/notification bar, which may be displayed on an upper portion of a display screen.

In operation 1230, when the files are received or have completed the receiving operation, one or more of the received files may be classified into one or more groups based on their metadata. For example, when a number of files are received, the classifying unit 120 may acquire file type information from the metadata of each file, and classify the received files into at least one of an image file group, an audio file group, a video file group, a text file group, and the like, according to the file type. However, aspects of the invention are not limited thereto, such that the classifying unit 120 may classify the received files into groups based on various criteria.

In operation 1240, the received files are displayed on according to its grouping, such that groups of files are displayed. For example, the display unit 130 may display each group of the received files using a status/notification bar, a popup window, icons resident in a given region of the display screen, or the like. Along with the group of the received files, various icons and/or information corresponding to the received files or groups may be provided. For example, various icons and/or information may include, without limitation, at least one of a number of files belonging to the group and the file size of the group may be displayed. Further, a share icon for showing a list of applications capable of supporting a sharing operation may also be displayed along with each group of the files to enable the sharing of the group of the files with other devices.

According to aspects of the invention, one or more operations may be simultaneously performed or performed in a different sequence. For example, the operation 1220 and the operation 1240 may be simultaneously performed if some files have been received and some are still in the process of being received or waiting to be received. More specifically, in addition to displaying the information regarding a reception status, the groups of the received files may be displayed in real time.

In operation 1250, applications which can be associated with the received files or the group of the received files are searched. Operation 1250 may be performed in response to a user's request to search for the applications capable of being associated with one or more files or groups, which may be selected by the user from among the received files or the groups of the files. Further, the related applications may be searched regardless of the user's request or instruction. For example, if the user selects image files from received files, the device may only display a list of the image files, while the application searching unit 140 may find the related applications that may execute the image files, such as image viewer applications, email applications, messaging applications for SMS or MMS, and the like.

In operation 1260, a list of the found applications is displayed. For example, in response to a user's selection of a particular received file or a particular group of received files, the display unit 130 may receive a list of application capable of being associated with the selected file or group and display the received list.

In operation 1270, in response to a user's selection of a particular application, the selected application is executed in association with the corresponding file.

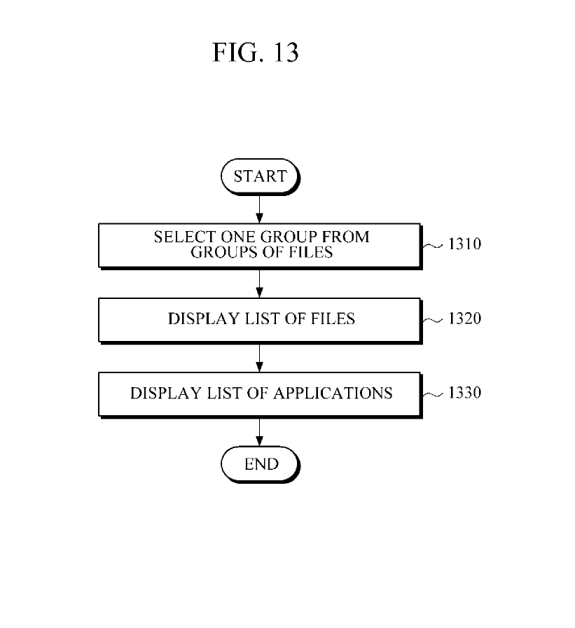

FIG. 13 is a flowchart illustrating a method for displaying a list of applications capable of executing a selected file or a group of files according to an exemplary embodiment of the present invention. In an example, FIG. 13 may provide a more detailed description of operation 1260 for displaying the list applications.

In operation 1310, the user selects one of groups of the received files.

A list of the received files belonging to the selected group is displayed in operation 1320. In operation 1330, a list of applications that may be capable of executing or interacting with one or more files included in the list of files is displayed.

Although operation 1320 and operation 1330 are illustrated as being executed in a particular sequence, aspects of the invention are not limited thereto, such that operation 1320 and operation 1330 may be performed in the opposite order. More specifically, operation 1320 may be performed subsequent to operation 1330, or both operation 1320 and operation 1330 may be performed simultaneously.

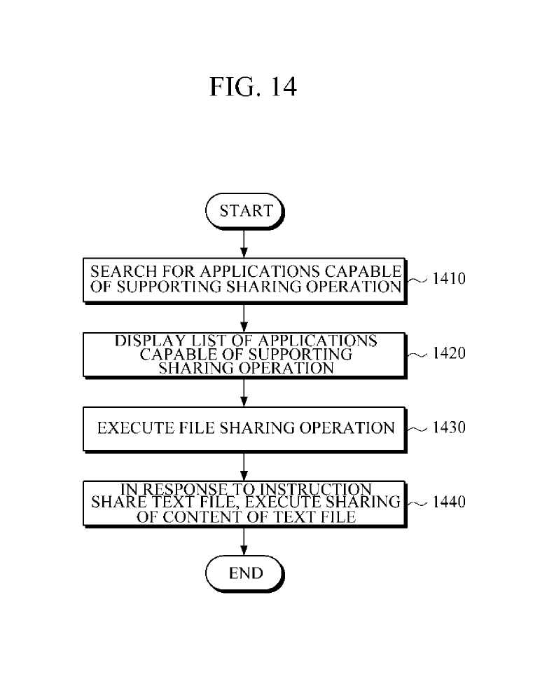

FIG. 14 illustrates a flowchart of a method for performing a sharing operation according to an exemplary embodiment of the present invention.

In operation 1410, applications capable of supporting a sharing operation are found. For example, the application searching unit 140 of FIG. 1 may search for applications capable of supporting a sharing operation. The applications capable of supporting a sharing operation may include, without limitation, Bluetooth® applications, SNS applications, email applications, messaging applications for SMS or MMS, and the like.

In operation 1420, in response to a user's instruction, a list of applications identified as being capable of supporting a sharing operation is displayed. For example, the display unit 130 may display a share icon to show the list of the applications capable of supporting a sharing operation along with a group of received files. In response to a user's selection of the share icon, the display unit 130 may display the list of the applications.

In operation 1430, in response to a user's selection of a particular application from the list, a file sharing operation is performed using the selected application. For example, in response to an email application being selected by the user, the email application may be executed with the received file being attached to an email generated by the email application.

If the received file is a text file and an instruction to share the text file is received, an operation for sharing the content of the text file is performed in operation 1440. For example, if the received text file contains text or content of “Pantech” and the user selects a messaging application to execute the respective file, the text or content “Pantech” may be entered in a message box of the messaging application when executed.

Further, the text file itself may be shared, instead of the content of the file.

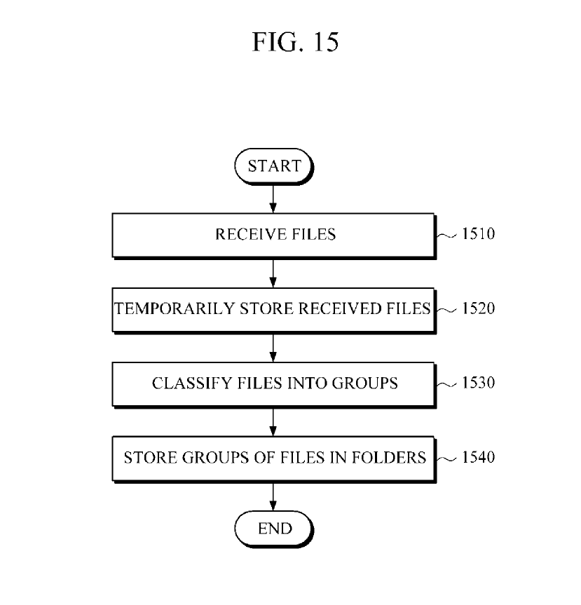

FIG. 15 illustrates a flowchart of a method for storing received files according to an exemplary embodiment of the present invention.

In operation 1510, one or more files are received in 1510.

The received files are temporarily stored in operation 1520, and the received files are classified into groups based on their metadata in operation 1530.

In operation 1540, the received files are stored in folders according to classified groups. For example, the storage unit 160 may store the files, which may be classified by the classifying unit 120, in folders which may have been previously determined or designated for each group prior to the complete receipt of the files. In another example, the storage unit 160 may store the received files in folders which have been designated by the user using the user interface 1011 after the complete receipt of the files. In yet another example, the storage unit 160 may store the received files in existing folders that correspond to metadata of the received files, or, if there is no folder corresponding to metadata of the received file, the storage unit 160 may create a folder based on the metadata and store the received file in the created folder.

As described above, when various types of files are received from an external device, the received files may be analyzed to categorize them into one or more groups, and information about the received files may be displayed on a group basis or on a file basis. As a result, it may be possible to increase user convenience in terms of management of received files.

In addition, the received files may be stored in folders set by the user or folders determined based on metadata. A user interface using icons or a notification window may be provided to allow the user to more easily identify or access the received files. Accordingly, it may be possible to reduce difficulty of the user from having to look through existing folders to find a desired file.

Further, applications capable of being associated with the received files may be displayed along with the received files or their corresponding groups, which may allow the user to directly execute the desired file using one of the displayed applications to potentially increase user convenience.

Further, the exemplary embodiments of the present invention can be embodied as computer-readable codes on a computer-readable recording medium. The computer-readable recording medium includes all kinds of recording devices storing data that is readable by a computer system. The computer-readable code may be executed by a computer having a processor and memory.

Examples of the computer-readable recording medium may include, without limitation, read-only memories (ROMs), random-access memories (RAMs), (compact disc) CD-ROMs, magnetic tapes, floppy disks, optical data storage devices, and carrier waves (e.g., data transmission through the Internet). The computer-readable recording medium may be distributed over network connected computer systems so that the computer-readable code is stored and executed in a distributed fashion. Various programs, code, and code segments that may be utilized for realizing aspects of the present invention may be deduced by computer programmers skilled in the art.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A method for managing a file receiving operation in a terminal device, the method comprising:
receiving a file from an external source;
displaying information of the file;
classifying the file into a group according to metadata corresponding to the file; and
providing a user interface for selecting the group.

2. The method of claim 1, wherein the information of the file comprises at least one of a name of the file, a file size of the file to be downloaded, a file type, an indication of a capability to support a sharing operation.

3. The method of claim 1, further comprising:
displaying status of the receiving operation of the file before the file has finished being received at the terminal device.

4. The method of claim 3, wherein the status of the receiving operation of the file comprises at least one of amount of data to be downloaded, amount of data that have completed downloading, a rate of reception, a start time of file receiving operation, an estimated finish time of the file receiving operation, and a progress bar corresponding to the receiving status of the file.

5. The method of claim 4, wherein the status of the receiving operation of the file further comprises:
a number of files to be downloaded and a number of files that have completed downloading if the file being received includes a plurality of files.

6. The method of claim 1, further comprising:
identifying an application capable of operating with the file based on metadata corresponding to the file.

7. The method of claim 6, further comprising:
executing the identified application,
wherein execution of the application automatically inserts contents of the file or attaches the file in a message generated by the executed application.

8. The method of claim 1, further comprising:
designating a folder to store the file to be received based on metadata corresponding to the file.

9. The method of claim 1, further comprising:
generating a folder to store the file to be received based on metadata corresponding to the file.

10. The method of claim 3, wherein at least one of the information of the file and the status of the receiving operation of the file is displayed on a status/notification bar.

11. A method for managing a received file, comprising:
classifying the file into a group;
displaying the group comprising the file for selection along with information corresponding to the group;
identifying an application capable of operating with the file for selection; and
executing the selected application.

12. The method of claim 11, wherein the displaying the group along with information corresponding to the group is displayed in a pop-up window.

13. The method of claim 12, wherein the displayed group is switched to display another group of files in response to a received input.

14. The method of claim 11, wherein the displaying the group along with information corresponding to the group is displayed in a status/notification screen.

15. The method of claim 11, wherein the displaying the group along with information corresponding to the group is displayed as an icon with a balloon-type notification.

16. The method of claim 11, wherein the file is classified when the file has finished being received from an external source.

17. An apparatus to manage a file in a terminal device, the apparatus comprising:
a receiving unit to receive a file from an external source;
a categorizing unit to categorize the file into a group; and
a display unit to display at least one of information of the file and group information corresponding to the group to which the file is categorized.

18. The apparatus of claim 17, further comprising:
an application searching unit to identify an application capable of operating with the file.

19. The apparatus of claim 17, wherein the display unit further displays status of the receiving operation of the file before the file has finished being received at the terminal device.

20. The apparatus of claim 17, further comprising:
a temporary storage unit to temporarily store at least a portion of the file that is being received until the receiving of the file is complete; and
a storage unit to store the received file in the group based on the categorization of the received file.

21. The apparatus of claim 20, wherein the file is categorized into a group based on metadata of the file.

22. The apparatus of claim 18, further comprising:
an application executing unit to execute the identified application,
wherein, when the application is executed, content of the file is inserted into a message generated by the application or the file is attached to the message.

23. The apparatus of claim 17, wherein the group information comprises at least one of a number of files included in the group, a total data size of the group, an indication of whether at least one of the files in the group is capable of supporting a sharing operation, and a time of last update.
